(19) United States
(12) Patent Application Publication
(10) Pub. No.: US 2010/0095448 A1
(43) Pub. Date: Apr. 22, 2010

(54) SWIMMING ENVIRONMENT WITH MULTIPLE TEMPERATURE REGIONS

(76) Inventors: Richard Goldmann, Poughkeepsie, NY (US); Russ Weinzimmer, Milford, NH (US); Douglas P. Burum, Acton, MA (US)

Correspondence Address: Russ Weinzimmer, 614 Nashua Street, Suite 53, Milford, NH, 03055, US

(21) Appl. No.: 12/253,984

(22) Filed: Oct. 19, 2008

(51) Int. Cl. E04H 4/14; G05D 23/00

(52) U.S. Cl. 4/505; 700/299

(57) ABSTRACT

A swimming environment is disclosed that enables a swimmer to select water of a desired temperature by moving between swimming regions that are separate swimming pools and/or sub-regions of a swimming pool. Pools can be divided into sub-regions by thermally isolating barriers that are sheets or strips hanging from floats, sheets attached to pool boundaries, or solid barriers. Strips can be flexible or rigid, and can be linked by magnets. Barriers can be designed to avoid swimmer injury and absorb wave energy. Swimmers can move past barriers without fully leaving the water by submerging floats, separating strips, moving through a barrier gap, traversing a slide, and/or moving through a door. Doors can be single or double, swinging, sliding, revolving, or pocket. A water temperature control system ensures that none of the regions exceeds 90 degrees Fahrenheit, and can include a heater, cooler, and/or heat pump.

### FIELD OF THE INVENTION

The invention generally relates to swimming environments, and more specifically to swimming environments with multiple regions.

### BACKGROUND OF THE INVENTION

Exercise is generally known to have many benefits for individuals of all ages. These benefits include improved cardiovascular health, reduced blood pressure, prevention of bone and muscle loss, maintenance of a healthy weight, improved psychological heath, and many others. However, most forms of exercise are generally accompanied by a certain degree of discomfort, including overheating, sweating, dehydration, loss of electrolytes, etc, and this leads to a significant reduction in the amount of exercise undertaken by many individuals, thereby reducing the health benefits derived from recreational and conditioning exercise.

Swimming laps and other forms of water exercise are known to be among the most beneficial forms of exercise, placing minimal stress on joints while simultaneously exercising a large number of muscle groups throughout the human body. When undertaken in water that is maintained at a relatively low temperature, swimming also offers the advantage of efficiently removing heat from the body during exercise, thereby avoiding the overheating, sweating, dehydration, loss of electrolytes, and discomforts associated with other forms of exercise. However, the initial entry into water maintained at a relatively low temperature can be highly uncomfortable, can tighten the muscles, and can generally discourage many exercisers from swimming as a form of exercise. On the other hand, water maintained at a relatively warmer temperature is typically experienced as comfortable, inviting, relaxing, and generally enjoyable. However, such warm water can also lead to a feeling of lethargy, and can cause exercise to be unappealing and uncomfortable.

Due to the high heat capacity of water and the volume of water needed for swimming, it is not practical to perceptibly change the temperature of water during a swimming workout. Instead, the typical approach is to choose a compromise temperature whereby the water is not too cold to overly discourage initial entry, and yet is not too warm to discourage exercise. Unfortunately, this comprise is far from ideal, since it tends to result in a swimming environment that is uncomfortable upon initial entry into the water, and yet is higher than the ideal exercising temperature.

Also, since a swimming environment is typically used by more than one swimmer, and since swimmers vary in their ages and physiologies, and therefore in their ideal swimming temperatures, it is impossible to adjust the temperature of a swimming environment so as to make it ideal for all swimmers.

### SUMMARY OF THE INVENTION

A swimming environment is claimed for enabling a swimmer to select water of a desired temperature by moving between swimming regions that are maintained at different temperatures. In preferred embodiments a swimmer can move between swimming regions without fully leaving the water. The swimming regions are at least somewhat thermally isolated from each other, each swimming region being either a separate swimming pool or a sub-region of a swimming pool that is separated from other sub-regions of the swimming pool by dividers located within the swimming pool. A water temperature control system maintains the swimming regions at different water temperatures, such that the water temperature does not exceed 90 degrees Fahrenheit in any of the swimming regions.

The invention is a swimming environment for enabling a swimmer to select water of a desired temperature by moving between regions in the swimming environment. The swimming environment includes a plurality of swimming regions, the swimming regions being at least partially thermally isolated from each other. Each swimming region is either a swimming pool or a sub-region of a swimming pool that is divided from other sub-regions of the swimming pool by dividers located within the swimming pool. The swimming environment also includes at least one water temperature control system that is able to maintain the swimming regions at different water temperatures, such that the water temperature does not exceed 90 degrees Fahrenheit in any of the swimming regions.

In preferred embodiments, the swimming regions are configured so as to allow a swimmer to move between two swimming regions without substantially leaving the water. In further preferred embodiments at least one swimming region is of sufficient dimensions to allow a swimmer to swim laps therein.

In some preferred embodiments the swimming environment includes a divider within a swimming pool that is suspended by floats, the floats being disposed in a substantially linear arrangement across the swimming pool. In other preferred embodiments the swimming environment includes a divider within a swimming pool that is attached to at least one a wall and a bottom of the swimming pool.

Certain preferred embodiments include a divider within a swimming pool that is secured along its bottom edge using an attachment mechanism. In some of these embodiments the attachment mechanism includes at least one of the following:

a track;

a magnet;

hook fabric cooperative with loop fabric;

glue;

a hook;

a grommet;

a ring bolt;

a weight;

tying strips;

an elastic attachment cord;

a snap; and

a zipper.

In various preferred embodiments the swimming environment includes a divider within a swimming pool that is formed from strips of material suspended so as to form a hanging curtain that divides the pool into sub-regions. In some of these embodiments the strips include magnets that tend to hold adjacent strips in close alignment and thereby minimize gaps between the strips, and in other of these embodiments each strip is flexibly connected along an edge of the strip to an edge of a neighboring strip.

In certain preferred embodiments the swimming environment includes a divider within a swimming pool that includes a single sheet of material that extends between two sides of the swimming pool and divides the swimming pool into sub-regions. In some preferred embodiments the swimming environment includes a divider within a swimming pool that includes substantially rigid slats.

In preferred embodiments the swimming environment includes a divider within a swimming pool that is at least partly a rigid wall. In some of these embodiments the at least partly rigid wall is made so as to avoid injury to swimmers, and in other of these embodiments the at least partly rigid wall is made so as to avoid injury to swimmers due to at least one of the following:

softness of a surface of the at least partly rigid wall;

shaping of the at least partly rigid wall that minimizes sharp features;

coloring that avoids accidental impacts with the partly rigid wall;

smoothness of the at least partly rigid wall that minimizes abrasions;

In preferred embodiments the swimming environment includes a divider within a swimming pool configured so as to allow a swimmer to pass between sub-regions of the swimming pool by manipulating the divider so as to allow passage from one side of the divider to another.

In other preferred embodiments a divider within a swimming pool extends incompletely across the swimming pool, thereby providing a gap that allows a swimmer to pass between adjacent sub-regions without leaving the water.

In certain preferred embodiments at least a portion of a divider within a swimming pool does not fully extend to the surface of the water, thereby allowing a swimmer to pass between adjacent sub-regions without leaving the water by passing over the divider in a region where it does not reach the surface of the water.

In various preferred embodiments a divider within a swimming pool includes an openable doorway through which a swimmer can pass between adjacent sub-regions without leaving the water, the doorway being closable so as to minimize the passage of water between the sub-regions. In some of these embodiments the doorway includes two doors configured with a space between the doors that is large enough to contain a swimmer, thereby allowing a swimmer to pass between adjacent sub-regions without leaving the water and without opening both of the doors simultaneously. In other of these embodiments the doorway includes a revolving door. And in still other of these embodiments the doorway slides laterally when being opened and closed.

In preferred embodiments a divider within a swimming pool is energy absorbent due to at least one of shape and material choice, so as to absorb wave energy generated within sub-regions of the swimming pool.

In some preferred embodiments a divider within a swimming pool is configured so as to minimize the transfer of wave energy between sub-regions of the swimming pool. In other preferred embodiments the swimming environment further includes a passage between two swimming pools that enables a swimmer to pass between the swimming pools without substantially leaving the water. And in still other preferred embodiments the swimming environment further includes a slide that facilitates passage of a swimmer between two swimming pools.

### BRIEF DESCRIPTION OF THE DRAWINGS

FIG. 1A is a perspective view of an embodiment of the invention in which a swimming pool is divided into two thermally independent swimming regions by a sheet of flexible material suspended from floats;

FIG. 1B is a perspective view of an embodiment similar to FIG. 1A, except that the two regions are divided by a barrier composed of adjacent hanging strips of material;

FIG. 1C is a close-up view of two of the strips of material from FIG. 1B. showing magnets attached to the edges of the strips;

FIG. 1D is a close up view of the two strips of FIG. 1C, wherein the adjacent edges have been overlapped and attached to each other due to attraction between the magnets;

FIG. 2A is a perspective view of an embodiment of the invention in which a swimming pool is divided into two thermally independent swimming regions by a sheet of material held in place by tracks on the sides of the pool and including shallow openings at each end to allow a swimmer to pass between the swimming regions;

FIG. 2B is a perspective view of an embodiment similar to the embodiment of FIG. 2A, except that the openings are deeper so as to allow a swimmer to remain submerged when passing between the swimming regions;

FIG. 2C is a perspective view of an embodiment similar to FIG. 2B, but with the addition of hinged doors in the openings;

FIG. 2D is a perspective view of an embodiment similar to FIG. 2B, but with the addition of revolving doors in the openings;

FIG. 3 is a top view of an embodiment of the invention in which a swimming pool is divided into two thermally independent swimming regions by a wide, rigid barrier with deep openings at each end and two hinged doors in each of the openings;

FIG. 4A is a close-up illustration of a hinged door that includes closable water passages shown in a closed configuration, wherein the water passages facilitate movement of the door when they are open and provide a thermal barrier when they are closed;

FIG. 4B is a close-up illustration of the hinged door of FIG. 4A with the water passages shown in an open configuration;

FIG. 5A is a top view of an embodiment of the invention in which a swimming pool is divided into two thermally independent swimming regions by a wide, rigid barrier with deep openings at each end and a pocket door in each of the openings;

FIG. 5B is a top view of an embodiment of the invention in which two swimming pools are separated by a wide, rigid barrier, the two swimming pools having different height and being connected by a slide that allows swimmers to traverse from the higher pool to the lower pool;

FIG. 5C is a cross sectional view of the embodiment of FIG. 5B, showing the different heights of the two swimming pools and the slide that connects them;

FIG. 6 is a top view of a preferred embodiment in which a swimming pool is divided into a plurality of thermally independent swimming regions by a plurality of barriers suspended from floats, the temperature of each of the swimming regions being independently controlled by a water heater that controls separate inlet and outlet ports in each of the swimming regions;

FIG. 7 is a top view of a preferred embodiment similar to FIG. 6, except that water from the heater flows sequentially through the swimming regions, thereby creating a continuous change of the water temperature through the swimming regions;

FIG. 8 is a top view of a preferred embodiment similar to FIG. 7, except that a heat pump is used to establish a temperature differential between the outermost swimming regions, thereby creating a continuous change of the water temperature across the swimming regions;

FIG. 9A is a top view of a preferred embodiment in which a large swimming pool is divided into two thermally independent swimming regions by a barrier suspended from floats, while a separate, small swimming pool provides an additional swimming region that is physically and thermally separated from the other two regions, the temperatures of all three regions being separately controlled by a heater; and

FIG. 9B is a top view of a preferred embodiment similar to FIG. 9A, but including a connection between the large swimming pool and the small swimming pool that enables a swimmer to pass between the swimming pools without leaving the water.

### DETAILED DESCRIPTION OF PREFERRED EMBODIMENTS

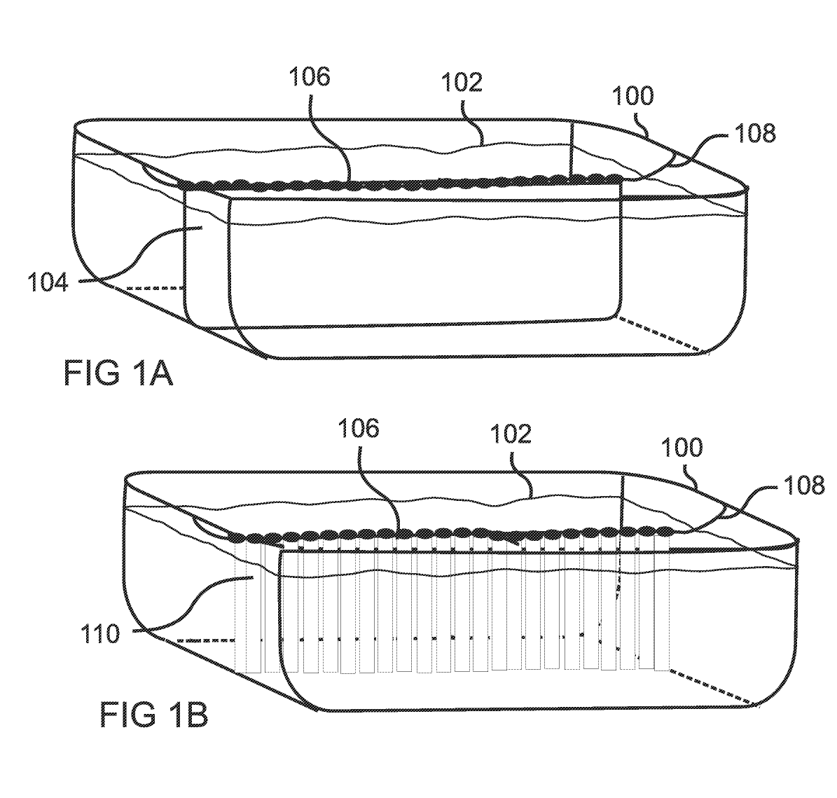

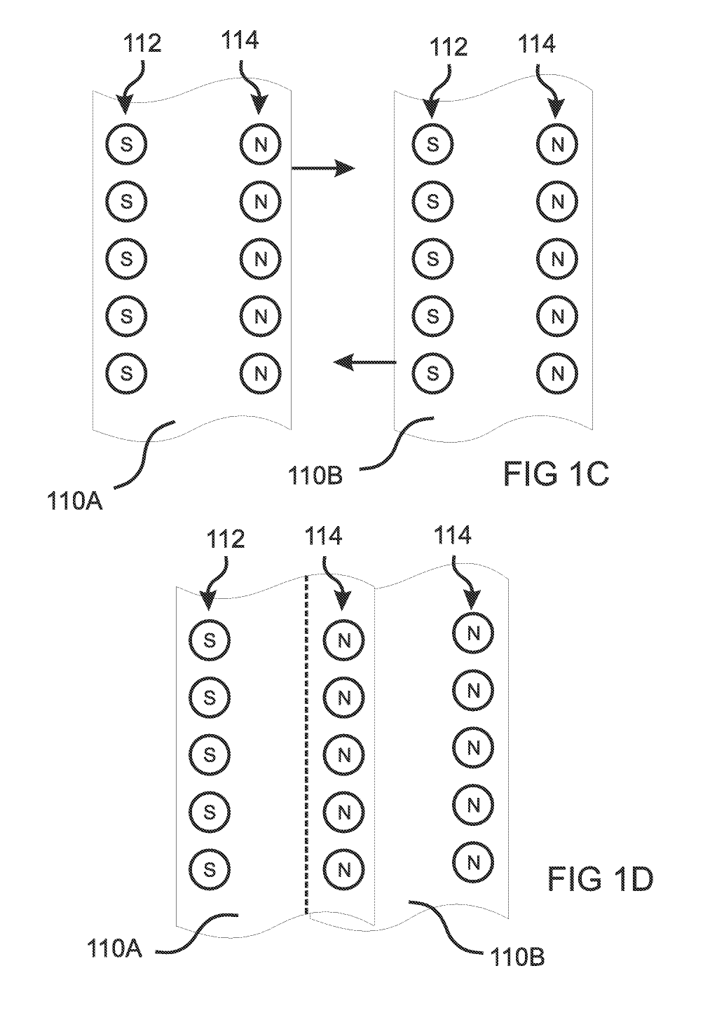

The invention is a swimming environment that includes a plurality of swimming regions maintained at different temperatures, so that a swimmer can select a desired water temperature by selecting a swimming region. In the preferred embodiment of FIG. 1A, the swimming environment is a single swimming pool 100 filled with water 102 and divided into two swimming regions by a sheet of flexible material 104 suspended from a line of floats 106 held in place by a rope 108 attached to opposing ends of the swimming pool 100. The swimming regions are maintained at different temperatures so as to accommodate swimmers who have different physiologies, different preferences, and/or who are performing exercise at different levels of exertion. The rope 108 is sufficiently long to allow a swimmer to push the line of floats 106 temporarily under the surface of the water 102, thereby allowing the swimmer to cross over the floats 106 and pass from one swimming region to the other.

FIG. 1B illustrates a preferred embodiment similar to FIG. 1A, in which the two swimming regions are divided by a series of strips of material 110 hanging from the floats 106. In some preferred embodiments, the strips 110 simply hang next to each other, while in other embodiments they are attached to each other by means well known in the art such as hook-and-loop attachment or magnets. In the embodiment of FIG. 1B a swimmer is able to pass between the swimming regions either by temporarily submerging the floats 106 as in FIG. 1A, or by temporarily separating a pair of strips and swimming between them.

FIG. 1C illustrates a pair of strips 110A, 110B that are able to attach to each other by magnetic means. Each of the strips 110A, 110B includes a column of magnets 112, 114 along each of its edges, the magnets being aligned so as to allow adjacent edges of the strips 110A, 110B to attach to each other, as shown in FIG. 1D, thereby holding the edges of the strips 110 together and forming an effective thermal barrier.

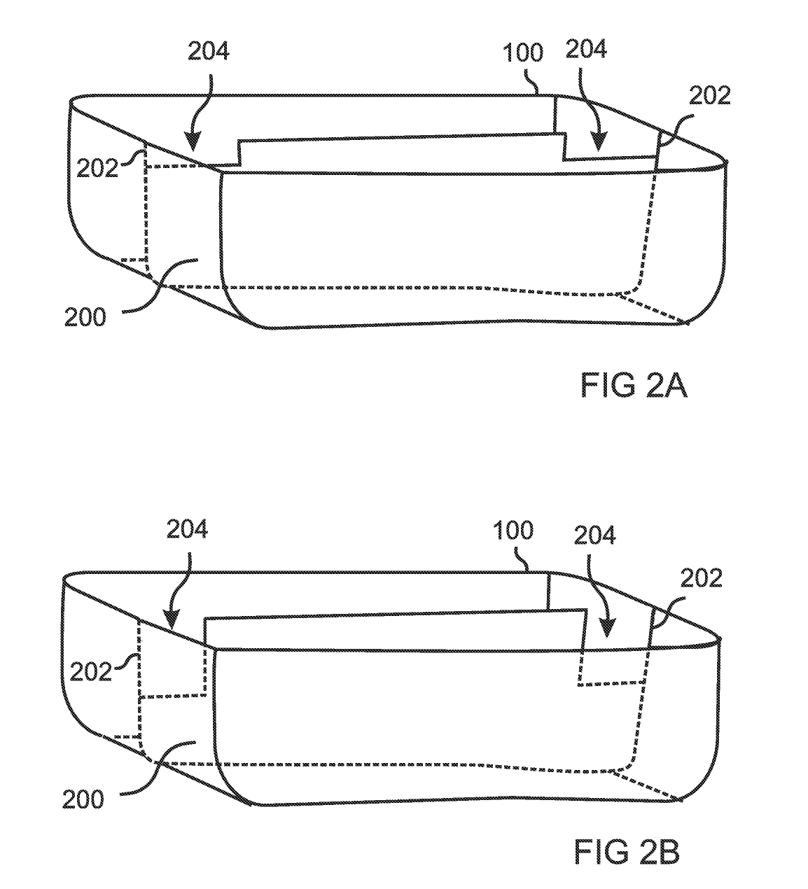

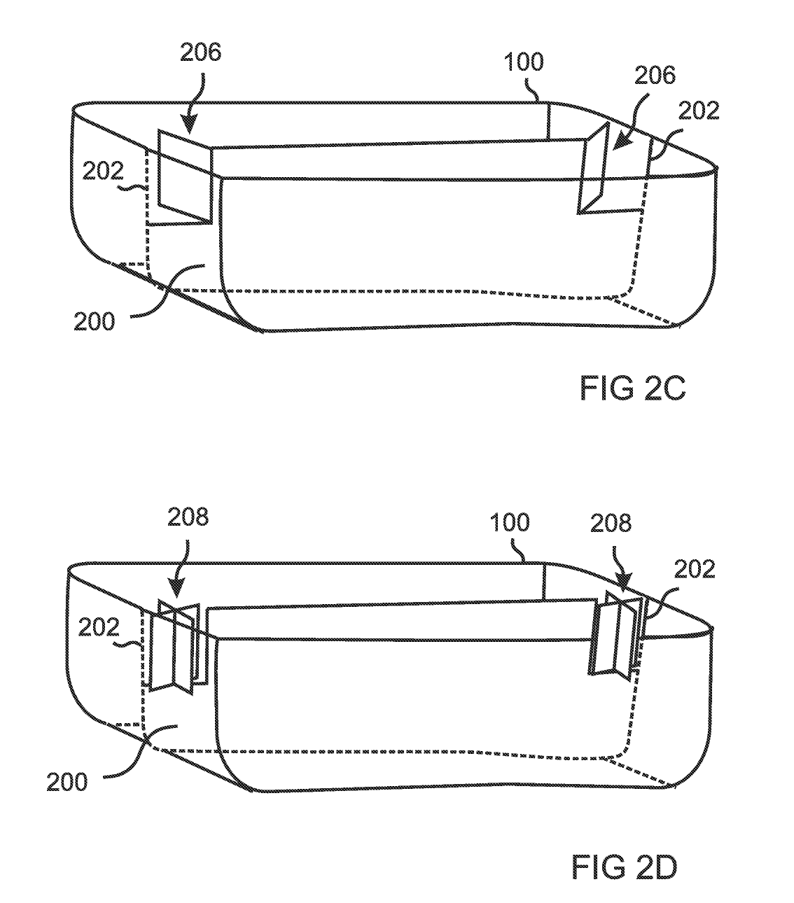

FIG. 2A illustrates a preferred embodiment in which the swimming environment is a single swimming pool 100 that is divided into two swimming regions by a rigid or semi-rigid sheet 200 that is held in place by tracks 202 attached to opposing walls of the swimming pool 100. The sheet 200 includes a shallow opening 204 at each end which allows a swimmer to pass between the swimming regions without fully leaving the water. FIG. 2B illustrates a similar embodiment in which the openings 204 are sufficiently deep to allow a swimmer to pass between the two swimming regions while remaining completely submerged.

In comparison with the embodiment of FIG. 2A, the embodiment of FIG. 2B provides a more convenient means for a swimmer to pass between the two swimming regions, at the expense of reduced thermal isolation between the swimming regions. In the embodiment of FIG. 2C this issue is addressed by providing a hinged door 206 in each of the openings 204, and in the embodiment of FIG. 2D a revolving door 208 is provided in each of the openings 204.

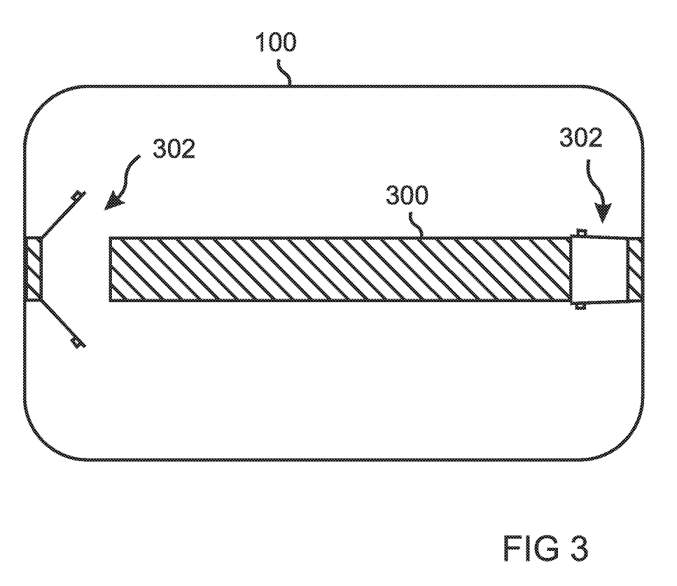

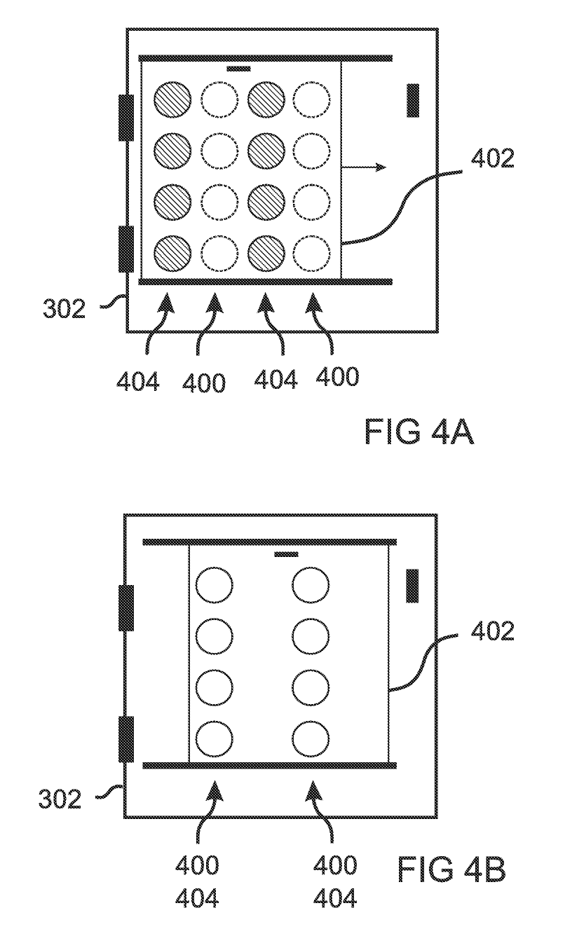

FIG. 3 illustrates a preferred embodiment in which the swimming environment is a single swimming pool 100 divided into two swimming regions by a wide, rigid barrier 300 with an opening at each end and with a pair of hinged doors 302 in each of the openings. By opening the hinged doors 302 one at a time, a swimmer is able to pass between the swimming regions while allowing only a minimal amount of water to pass between the two regions, thereby minimizing the transfer of heat between the swimming regions.

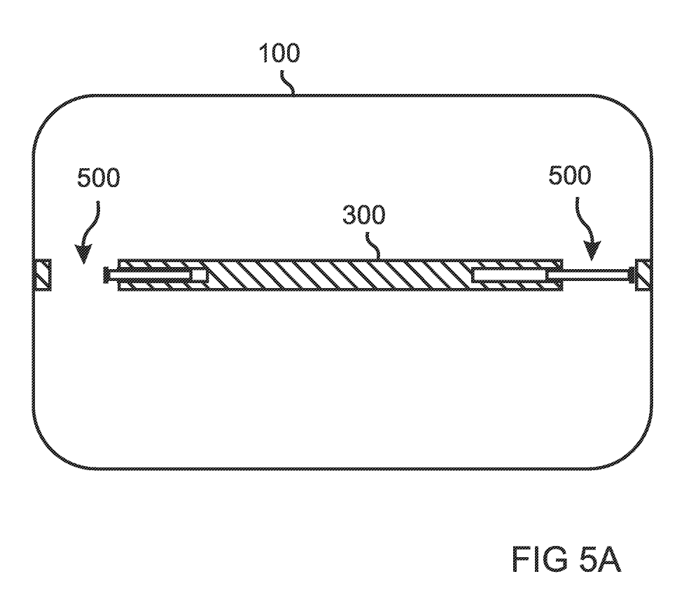

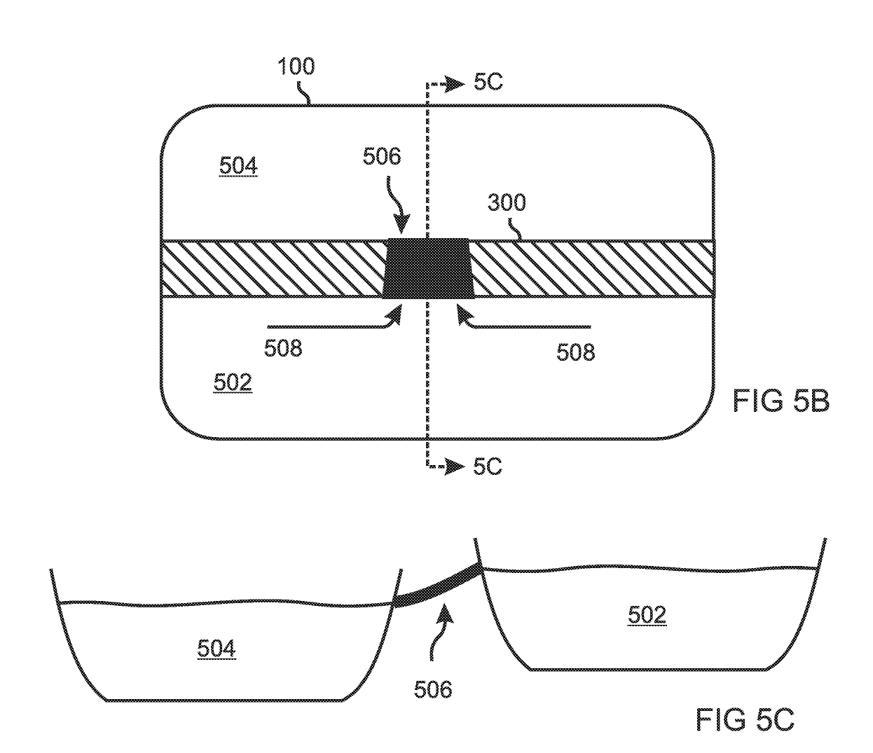

FIG. 5A illustrates a preferred embodiment similar to the embodiment of FIG. 3A in which pocket doors 500 are included in the openings, thereby avoiding the problem of water resistance to movement of the doors. In a similar embodiment, the barrier between swimming regions is wider and a pair of pocket doors is provided in each opening so as to minimize transfer of water between the swimming regions when a swimmer passes through.

FIG. 5B is a top view of a preferred embodiment in which the swimming environment includes two separate swimming pools 502, 504 that are separated by a wide, rigid barrier 300. One of the swimming pools 502 is slightly higher in elevation than the other one 504, and the two swimming pools 502, 504 are connected by a water slide 506 that enables a swimmer to conveniently traverse from the higher pool 502 to the lower pool 504. A small volume of water 508 flows continuously over the slide, so as to facilitate sliding of a swimmer from one pool 502 to the other pool 504. FIG. 5C is a cross sectional view of the embodiment of FIG. 5B, showing the different heights of the two swimming pools and the slide that connects them.

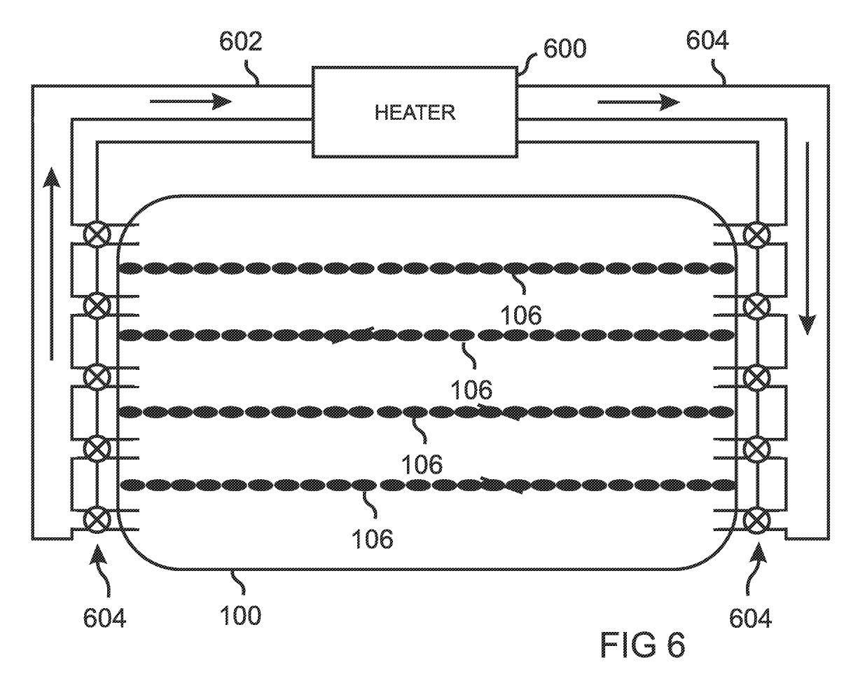

FIG. 6 illustrates a preferred embodiment in which the swimming environment is a single swimming pool 100 that is divided into a plurality of swimming regions by a plurality of barriers suspended from rows of floats 106. The temperatures of the swimming regions are controlled by a heater 600 with an inlet pipe 602 and an outlet pipe 604, each of which has separate connections to each of the swimming regions with separately controlled valves 604. By separately adjusting the valves 604, the heater 600 can separately control the amount of heat delivered to each of the swimming regions, thereby maintaining a separate temperature in each of the swimming regions. In preferred embodiments, a temperature sensor (not shown) is provided in each of the swimming regions so as to allow the heater to maintain the water temperature in each of the swimming regions at a desired value. In other preferred embodiments where the ambient temperature is high, a water cooling system is included in addition to or instead of the water heater 600.

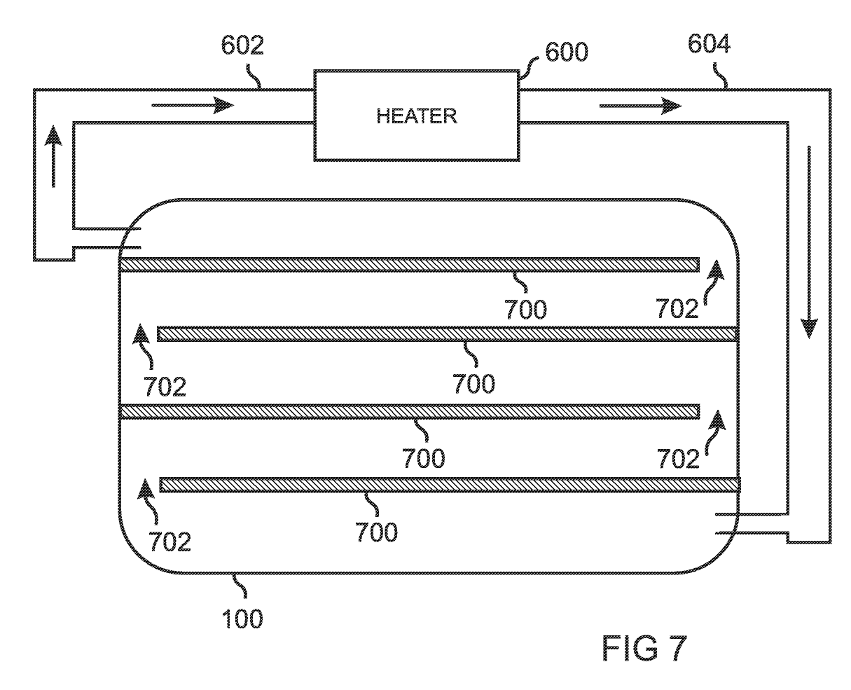

FIG. 7 illustrates a preferred embodiment in which a single swimming pool 100 is divided into a plurality of swimming regions by a plurality of rigid barriers 700, each of which includes an opening 702 at one end, the openings 702 being at alternate ends of the barriers 700. The heater 600 includes an inlet 602 and an outlet 604 connected at opposite corners of the swimming pool 100, thereby causing a flow of water that passes sequentially through all of the swimming regions. The result is a continuous change of the water temperature through the swimming regions, with a temperature range that is determined by the temperature of the water supplied by the heater and the rate at which water circulates through the swimming pool 100.

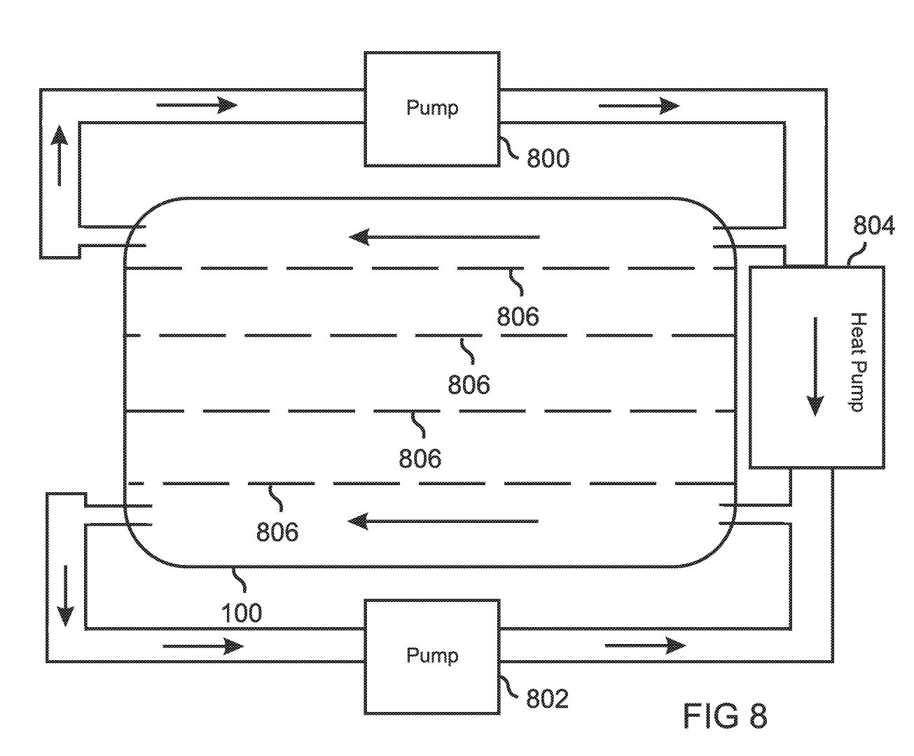

FIG. 8 illustrates yet another preferred embodiment of the present invention. In this embodiment, the swimming environment is a single swimming pool 100. Two water pumps 800, 802 circulate water through swimming regions on opposite sides of the swimming pool 100 while a heat pump 804 maintains a temperature differential between the two swimming regions by pumping heat from one of the regions 800 to the other 802. A series of rigid or semi-rigid barriers 806 divides the remainder of the swimming pool 100 into a plurality of additional swimming regions, and openings in the barriers 806 allow water to leak between adjacent swimming regions. The result is a continuous difference between the water temperatures in the swimming regions that is determined by the rate at which the heat pump 804 transfers heat from one side to the other, and the rate at which heat leaks between adjacent swimming regions.

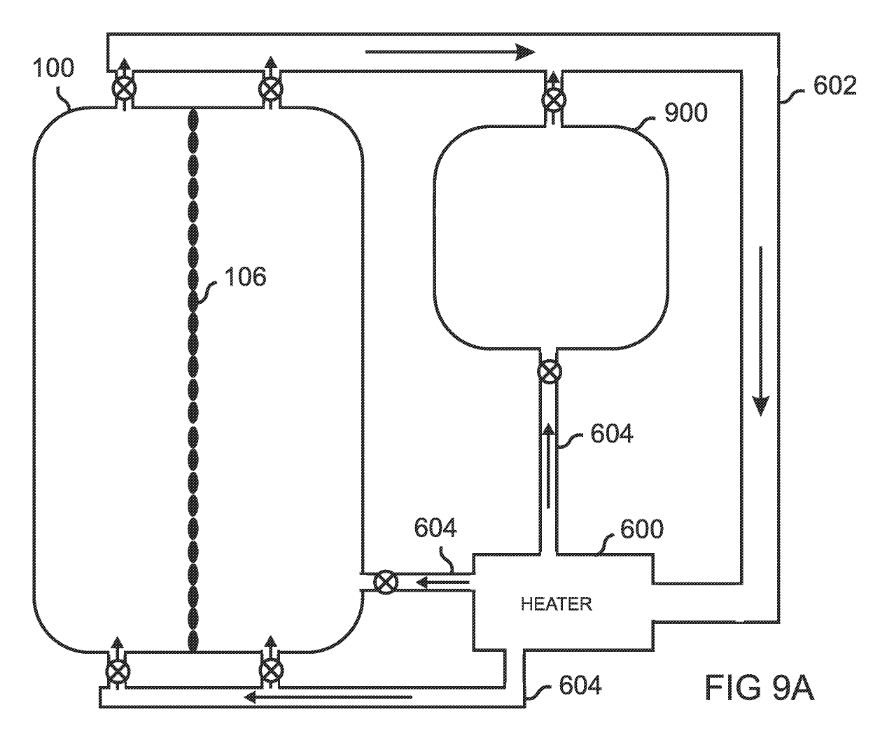

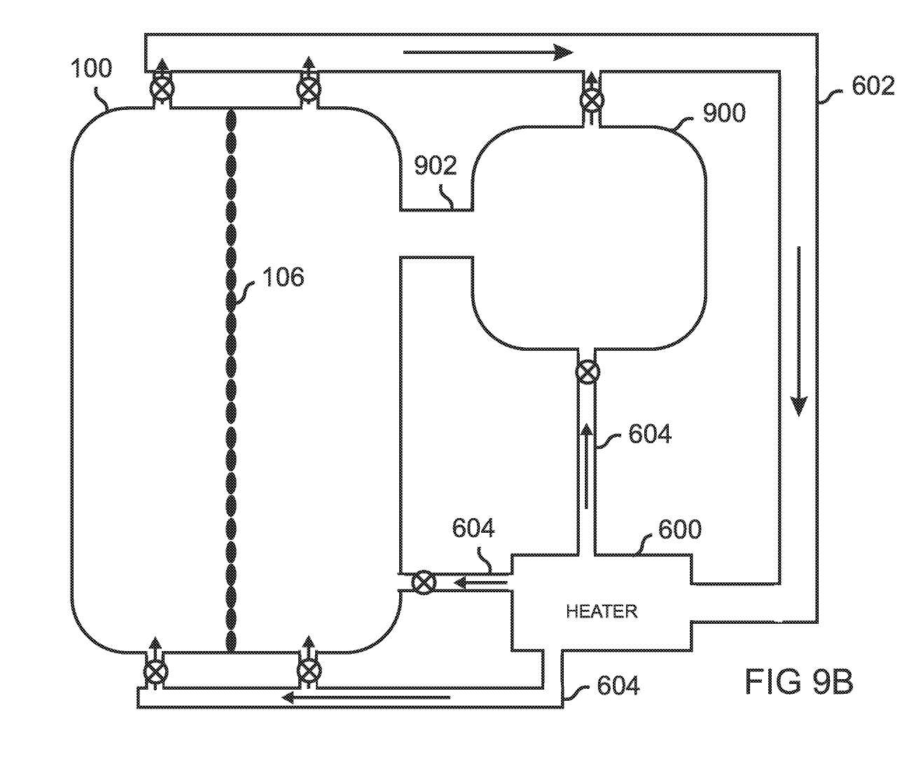

FIG. 9A illustrates a preferred embodiment in which the swimming environment includes a large swimming pool 100 and a small swimming pool 900. The large swimming pool 100 is divided by a flexible barrier suspended from floats 106 into two swimming regions that are used for swimming laps and for other forms of water exercise. The swimming regions in the large swimming pool 100 are maintained at temperatures that are appropriate for a swimmer undergoing exercise. The swimming regions differ in temperature so as to accommodate swimmers who have different physiologies and/or who are performing exercise at different levels of exertion. The smaller pool 900 is a single swimming region, and is maintained at a temperature that is somewhat warmer than the two swimming regions in the large swimming pool 100, thereby providing a more comfortable environment for swimmers to become accustomed to the water before moving to the larger swimming pool 900 and beginning an exercise session. FIG. 9B illustrates an embodiment similar to FIG. 9A, except that a channel 902 is included between the small swimming pool 900 and the large swimming pool 100, so as to allow a swimmer to pass between the two swimming pools 100, 900 without leaving the water.

Other modifications and implementations will occur to those skilled in the art without departing from the spirit and the scope of the invention as claimed. Accordingly, the above description is not intended to limit the invention except as indicated in the following claims.

What is claimed is:

1. A swimming environment for enabling a swimmer to select water of a desired temperature by moving between regions in the swimming environment, the swimming environment comprising:
a plurality of swimming regions, the swimming regions being at least partially thermally isolated from each other, each swimming region being one of:
a swimming pool; and
a sub-region of a swimming pool that is divided from other sub-regions of the swimming pool by dividers located within the swimming pool; and
at least one water temperature control system, the at least one water temperature control system being able to maintain the swimming regions at different water temperatures, such that the water temperature does not exceed 90 degrees Fahrenheit in any of the swimming regions.

2. The swimming environment of claim 1, wherein the swimming regions are configured so as to allow a swimmer to move between two swimming regions without substantially leaving the water.

3. The swimming environment of claim 1, wherein at least one swimming region is of sufficient dimensions to allow a swimmer to swim laps therein.

4. The swimming environment of claim 1, including a divider within a swimming pool that is suspended by floats, the floats being disposed in a substantially linear arrangement across the swimming pool.

5. The swimming environment of claim 1, including a divider within a swimming pool that is attached to at least one a wall and a bottom of the swimming pool.

6. The swimming environment of claim 1, including a divider within a swimming pool that is secured along its bottom edge using an attachment mechanism.

7. The swimming environment of claim 6, wherein the attachment mechanism includes at least one of:
a track;
a magnet;
hook fabric cooperative with loop fabric;
glue;
a hook;
a grommet;
a ring bolt;
a weight;
tying strips;
an elastic attachment cord;
a snap; and
a zipper.

8. The swimming environment of claim 1, including a divider within a swimming pool that is formed from strips of material suspended so as to form a hanging curtain that divides the pool into sub-regions.

9. The swimming environment of claim 8, wherein the strips include magnets that tend to hold adjacent strips in close alignment and thereby minimize gaps between the strips.

10. The swimming environment of claim 8, wherein each strip is flexibly connected along an edge of the strip to an edge of a neighboring strip.

11. The swimming environment of claim 1, including a divider within a swimming pool that includes a single sheet of material that extends between two sides of the swimming pool and divides the swimming pool into sub-regions.

12. The swimming environment of claim 1, including a divider within a swimming pool that includes substantially rigid slats

13. The swimming environment of claim 1, including a divider within a swimming pool that is at least partly a rigid wall.

14. The swimming environment of claim 13, wherein the at least partly rigid wall is made so as to avoid injury to swimmers.

15. The swimming environment of claim 14, wherein the at least partly rigid wall is made so as to avoid injury to swimmers due to at least one of:
softness of a surface of the at least partly rigid wall;
shaping of the at least partly rigid wall that minimizes sharp features;
coloring that avoids accidental impacts with the partly rigid wall;
smoothness of the at least partly rigid wall that minimizes abrasions;

16. The swimming environment of claim 1, including a divider within a swimming pool configured so as to allow a swimmer to pass between sub-regions of the swimming pool by manipulating the divider so as to allow passage from one side of the divider to another.

17. The swimming environment of claim 1, wherein a divider within a swimming pool extends incompletely across the swimming pool, thereby providing a gap that allows a swimmer to pass between adjacent sub-regions without leaving the water.

18. The swimming environment of claim 1, wherein at least a portion of a divider within a swimming pool does not fully extend to the surface of the water, thereby allowing a swimmer to pass between adjacent sub-regions without leaving the water by passing over the divider in a region where it does not reach the surface of the water.

19. The swimming environment of claim 1, wherein a divider within a swimming pool includes an openable doorway through which a swimmer can pass between adjacent sub-regions without leaving the water, the doorway being closable so as to minimize the passage of water between the sub-regions.

20. The swimming environment of claim 19, wherein the doorway includes two doors configured with a space between the doors that is large enough to contain a swimmer, thereby allowing a swimmer to pass between adjacent sub-regions without leaving the water and without opening both of the doors simultaneously.

21. The swimming environment of claim 19, wherein the doorway includes a revolving door.

22. The swimming environment of claim 19, wherein the doorway slides laterally when being opened and closed.

23. The swimming environment of claim 1, wherein a divider within a swimming pool is energy absorbent due to at least one of shape and material choice, so as to absorb wave energy generated within sub-regions of the swimming pool.

24. The swimming environment of claim 1, wherein a divider within a swimming pool is configured so as to minimize the transfer of wave energy between sub-regions of the swimming pool.

25. The swimming environment of claim 1, further comprising a passage between two swimming pools that enables a swimmer to pass between the swimming pools without substantially leaving the water.

26. The swimming environment of claim 1, further comprising a slide that facilitates passage of a swimmer between two swimming pools.

27. The swimming environment of claim 1, wherein the water temperature control system includes at least one of a water heater, a water cooler, and a heat pump.
